(19) United States
(12) Patent Application Publication
(10) Pub. No.: US 2019/0311525 A1
(43) Pub. Date: Oct. 10, 2019

(54) AUGMENTED REALITY OBJECT CLUSTER RENDERING AND AGGREGATION

(71) Applicant: Lumini Corporation, San Diego, CA (US)

(72) Inventor: Nils Forsblom, San Diego, CA (US)

(21) Appl. No.: 16/377,145

(22) Filed: Apr. 5, 2019

Related U.S. Application Data
(60) Provisional application No. 62/653,299, filed on Apr. 5, 2018.

(51) Int. Cl. G06T 15/20; G06T 19/00; G06T 19/20; H04W 4/02; G06F 3/01

(52) U.S. Cl. CPC G06T 15/205; G06T 19/006; G06F 3/011; H04W 4/026; G06T 19/20

(57) ABSTRACT

The selectively aggregation of augmented reality objects in a live camera view involves receiving a plurality of augmented reality objects in response to a query. Each of the augmented reality objects are associated with an object location on a map. A viewpoint location of a mobile computing device displaying a live camera view is received. For each of the augmented reality objects, a display location within the live camera view is calculated from the object location of the augmented reality object and the viewpoint location. An aggregate marker is displayed within the live camera view in response to the display locations of two or more of the augmented reality objects differing by less than a threshold.

### CROSS-REFERENCE TO RELATED APPLICATIONS

The present application relates to and claims the benefit of U.S. Provisional Application No. 62/653,299 filed Apr. 5, 2018 and entitled “AUGMENTED REALITY OBJECT CLUSTER RENDERING AND AGGREGATION,” the entire disclosure of which is hereby wholly incorporated by reference.

### STATEMENT RE: FEDERALLY SPONSORED RESEARCH/DEVELOPMENT

Not Applicable

### BACKGROUND

### 1. Technical Field

The present disclosure relates generally to human-computer interfaces and mobile devices, and more particularly, to the rendering and aggregation of augment reality object clusters.

### 2. Related Art

Mobile devices such as smartphones and tablets fulfill a variety of roles. Although such devices can take on different form factors with varying dimensions, there are several commonalities between devices that share this designation. These include a general-purpose data processor that executes pre-programmed instructions, along with wireless communication modules by which data is transmitted and received. The processor further cooperates with multiple input/output devices, including combination touch input display screens, audio components such as speakers, microphones, and related integrated circuits, GPS modules, and physical buttons/input modalities. More recent devices also include accelerometers, gyroscopes, and compasses/magnetometers that can sense motion and direction. For portability purposes, these components are powered by an on-board battery. Several distance and speed-dependent communication protocols may be implemented, including longer range cellular network modalities such as GSM (Global System for Mobile communications), CDMA (Code Division Multiple Access), and so forth, high speed local area networking modalities such as WiFi, and short-range device-to-device data communication modalities such as Bluetooth.

Management of these hardware components is performed by a mobile operating system, also referenced in the art as a mobile platform. Currently, popular mobile platforms include Android from Google, Inc., iOS from Apple, Inc., and Windows Phone, from Microsoft, Inc. The mobile operating system provides several fundamental software modules and a common input/output interface that can be used by third party applications via application programming interfaces. This flexible development environment has led to an explosive growth in mobile software applications, also referred to in the art as “apps.” Third party apps are typically downloaded to the target device via a dedicated app distribution system specific to the platform, and there are a few simple restrictions to ensure a consistent user experience.

User interaction with the mobile computing device, including the invoking of the functionality of these applications and the presentation of the results therefrom, is, for the most part, restricted to the graphical touch user interface. That is, the extent of any user interaction is limited to what can be displayed on the screen, and the inputs that can be provided to the touch interface are similarly limited to what can be detected by the touch input panel. Touch interfaces in which users tap, slide, flick, and pinch regions of the sensor panel overlaying the displayed graphical elements with one or more fingers, as well as other multi-gestures and custom multi-gestures, particularly when coupled with corresponding animated display reactions responsive to such actions, may be more intuitive than conventional keyboard and mouse input modalities associated with personal computer systems. Thus, minimal training and instruction is required for the user to operate these devices.

However, as noted previously, mobile computing devices must have a small footprint for portability reasons. Depending on the manufacturer's specific configuration, the screen may be three to five inches diagonally. One of the inherent usability limitations associated with mobile computing devices is the reduced screen size; despite improvements in resolution allowing for smaller objects to be rendered clearly, buttons and other functional elements of the interface nevertheless occupy a large area of the screen. Notwithstanding the enhanced interactivity possible with multi-touch input gestures, the small display area remains a significant restriction of the mobile computing device user interface. Although tablet form factor devices have larger screens than the typical smartphone, compared to desktop or even laptop computer systems, the screen size is still limited.

Expanding beyond the confines of the touch interface, some app developers have utilized the integrated accelerometer as an input means. Some applications such as games are suited for motion-based controls, and typically utilize roll, pitch, and yaw rotations applied to the mobile computing device as inputs that control an on-screen element. An application that combines many of the foregoing input and output capabilities of the mobile computing device is augmented reality. The on-board camera may capture footage of the environment presented on the display overlaid with information based on location data. The motion inputs captured by the MEMS sensors can be used to interact with the reproduced environment on the display, as can touch inputs. An augmented reality application is particularly useful for guiding user at a given locale and presenting potentially relevant location-based points of interest information such as restaurants, gas stations, convenience stores, and the like.

Visually presenting numerous points of interest data within an augmented reality display may be challenging due to the limited space in which they may be shown. The screen size limitation is particularly acute when there are many map overlays and objects or point of interest indicators to display. Attempting to render each overlay and object may result in a disorganized clutter, and block the camera view. The maximum number of augmented reality objects that can be rendered on the display at any given point is also limited by the data processing resources of the mobile computing device. Thus, there is a need in the art for an improved aggregation and rendering of augment reality object clusters.

### SUMMARY

An embodiment is the present disclosure is a method for selectively aggregating augmented reality objects in a live camera view. The method may include receiving a plurality of augmented reality objects in response to a query. Each of the augmented reality objects may be associated with an object location on a map. The method may also include receiving a viewpoint location of a mobile computing device displaying a live camera view. For each of the augmented reality objects, there may be a step of calculating a display location within the live camera view. The display location may be calculated from the object location of the augmented reality object and the viewpoint location. The method may also include displaying an aggregate marker within the live camera view in response to the display locations of two or more of the augmented reality objects differing by less than a threshold. This method may be implemented as a series of instructions executable by a data processor and tangibly embodied in a program storage medium.

Another embodiment of the present disclosure is directed to system for selectively aggregating augmented reality objects in a live camera view. The system, may include a mobile computing device operable to display a live camera view. There may also be one or more servers that receive a plurality of augmented reality objects in response to a query. Each of the augmented reality objects may be associated with an object location on a map. Furthermore, the server may receive a viewpoint location of the mobile computing device, and, for each of the augmented reality objects, calculate a display location within the live camera view. The display location may be calculated from the object location of the augmented reality object and the viewpoint location. The mobile computing device may display an aggregate marker within the live camera view in response to the display locations of two or more of the augmented reality objects differing by less than a threshold.

The present invention will be best understood by reference to the following detailed description when read in conjunction with the accompanying drawings.

### BRIEF DESCRIPTION OF THE DRAWINGS

These and other features and advantages of the various embodiments disclosed herein will be better understood with respect to the following description and drawings, in which like numbers refer to like parts throughout, and in which:

FIG. 1 depicts an exemplary augmented reality environment in the context of which various embodiments of the present disclosure may be implemented;

FIG. 2 is a block diagram of a mobile computing device that may be utilized in the embodiments of the present disclosure;

FIG. 3 is a flowchart illustrating one embodiment of a method for selectively aggregating augmented reality objects;

FIG. 4 shows an augmented reality environment in which a plurality of objects are represented with aggregate markers in accordance with various embodiments of the present disclosure; and

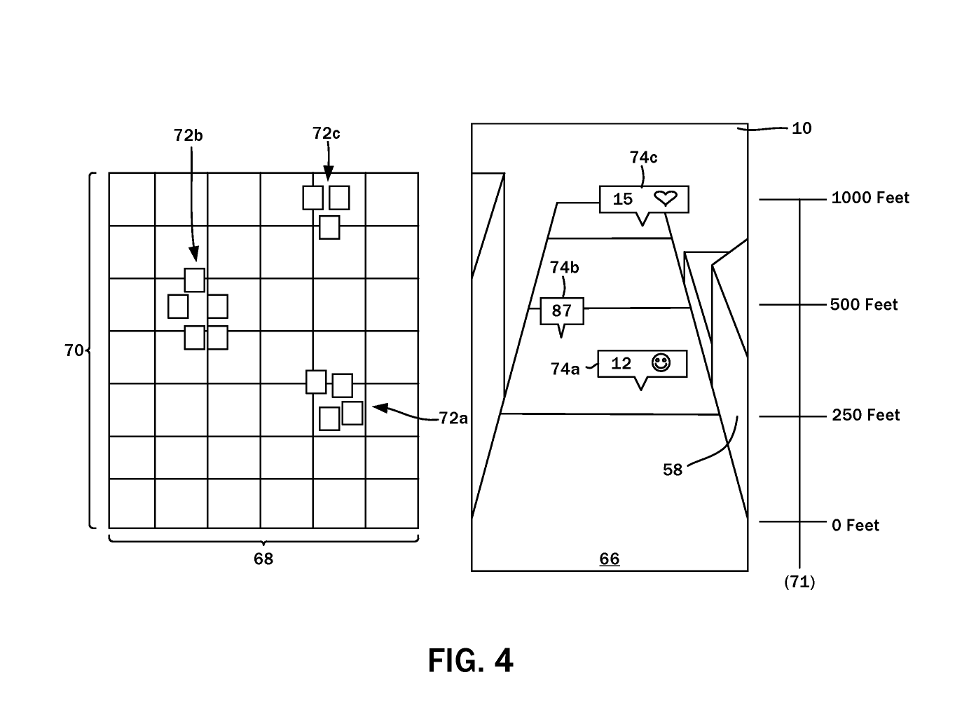

FIG. 5 is a representation of a map grid system utilized in the augmented reality environment.

### DETAILED DESCRIPTION

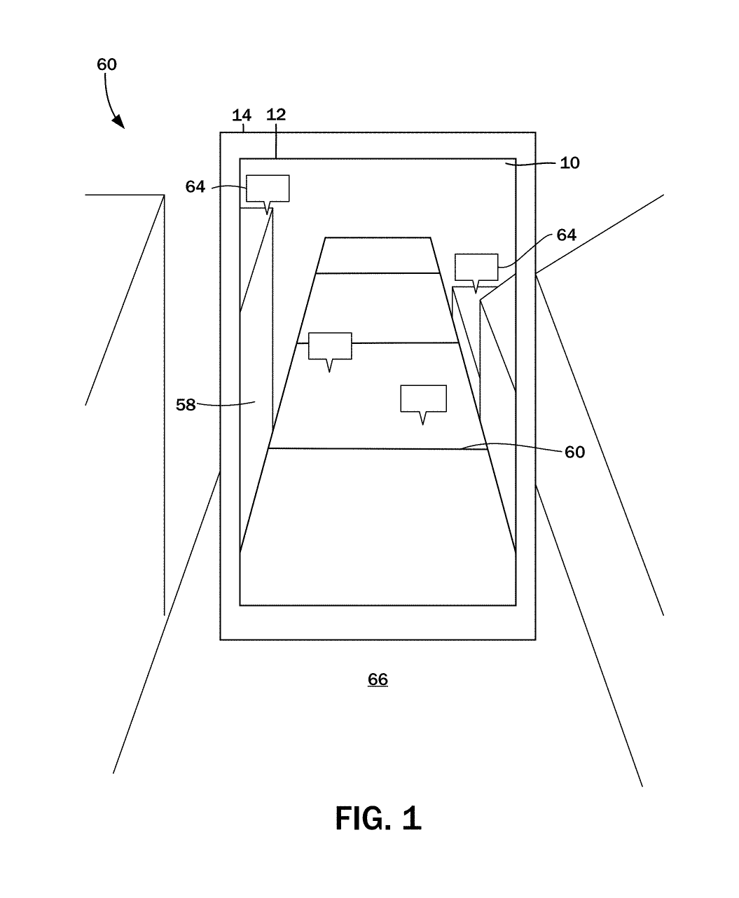

The present disclosure is directed to an interface, a system, and a method for aggregating and rendering clusters of augmented reality objects. In an exemplary embodiment as shown in FIG. 1, the foundational augmented reality system upon which the present disclosure is built presents an interactive simulated three-dimensional view of a physical space on a display 12 of a mobile computing device 14. This interface may also be referred to as an augmented reality environment 10, and is thus understood to reproduce the physical space with computer-generated visuals being layered thereon. The replicated physical space may be as small as a single room or a building, to a city block, or as expansive as an entire geographic region, and may have varying geometric configurations and dimensions.

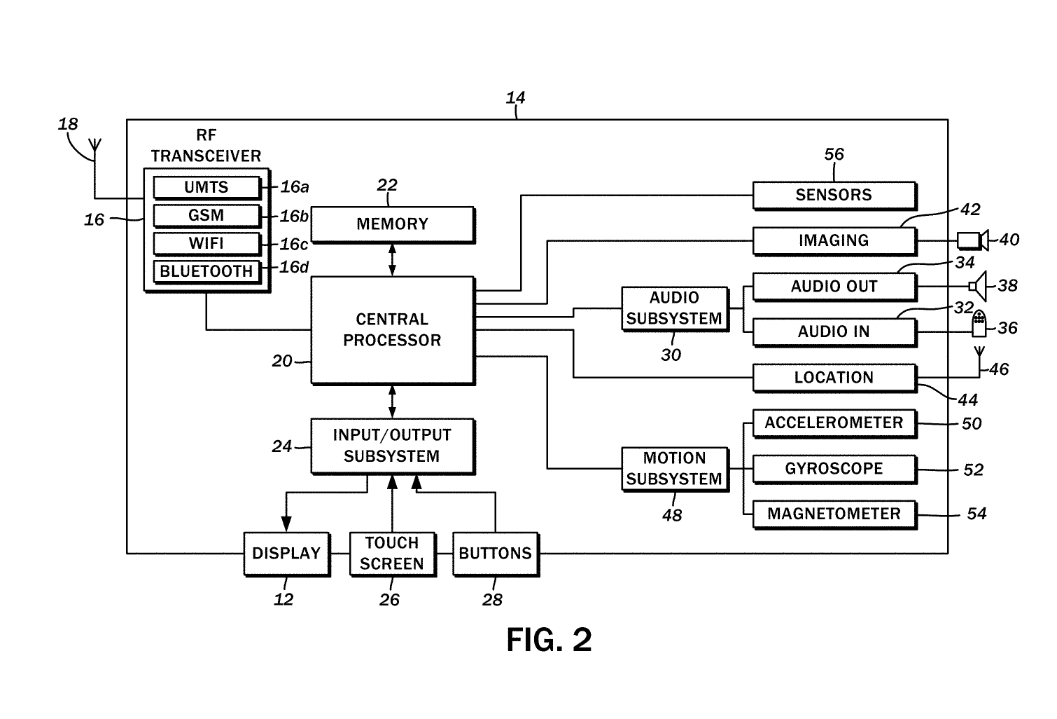

FIG. 2 illustrates one exemplary mobile computing device 14, which may be a smartphone, and therefore include a radio frequency (RF) transceiver 16 that transmits and receives signals via an antenna 18. Conventional devices are capable of handling multiple wireless communications modes simultaneously. These include several digital phone modalities such as UMTS (Universal Mobile Telecommunications System), 4G LTE (Long Term Evolution), and the like. For example, the RF transceiver 16 includes a UMTS module 16a. To the extent that coverage of such more advanced services may be limited, it may be possible to drop down to a different but related modality such as EDGE (Enhanced Data rates for GSM Evolution) or GSM (Global System for Mobile communications), with specific modules therefor also being incorporated in the RF transceiver 16, for example, GSM module 16b. Aside from multiple digital phone technologies, the RF transceiver 16 may implement other wireless communications modalities such as WiFi for local area networking and accessing the Internet by way of local area networks, and Bluetooth for linking peripheral devices such as headsets. Accordingly, the RF transceiver may include a WiFi module 16c and a Bluetooth module 16d. The enumeration of various wireless networking modules is not intended to be limiting, and others may be included without departing from the scope of the present disclosure.

The mobile computing device 14 is understood to implement a wide range of functionality through different software applications, which are colloquially known as “apps” in the mobile computing device context. The software applications are comprised of pre-programmed instructions that are executed by a central processor 20 and that may be stored on a memory 22. There may be other embodiments, however, utilizing self-evolving instructions such as with Artificial Intelligence (AI) systems. The results of these executed instructions may be output for viewing by a user, and the sequence/parameters of those instructions may be modified via inputs from the user. To this end, the central processor 20 interfaces with an input/output subsystem 24 that manages the output functionality of the display 12 and the input functionality of a touch screen 26 and one or more buttons 28. The software instructions comprising apps may be pre-stored locally on the mobile computing device 14, though web-based applications that are downloaded and executed concurrently are also contemplated.

In a conventional smartphone device, the user primarily interacts with a graphical user interface that is generated on the display 12 and includes various user interface elements that can be activated based on haptic inputs received on the touch screen 26 at positions corresponding to the underlying displayed interface element. One of the buttons 28 may serve a general purpose escape function, while another may serve to power up or power down the mobile computing device 14. Additionally, there may be other buttons and switches for controlling volume, limiting haptic entry, and so forth. Those having ordinary skill in the art will recognize other possible input/output devices that could be integrated into the mobile computing device 14, and the purposes such devices would serve. Other smartphone devices may include keyboards (not shown) and other mechanical input devices, and the presently disclosed interaction methods with the graphical user interface detailed more fully below are understood to be applicable to such alternative input modalities.

The mobile computing device 14 includes several other peripheral devices. One of the more basic is an audio subsystem 30 with an audio input 32 and an audio output 34 that allows the user to conduct voice telephone calls. The audio input 32 is connected to a microphone 36 that converts sound to electrical signals, and may include amplifier and ADC (analog to digital converter) circuitry that transforms the continuous analog electrical signals to digital data. Furthermore, the audio output 34 is connected to a loudspeaker 38 that converts electrical signals to air pressure waves that result in sound, and may likewise include amplifier and DAC (digital to analog converter) circuitry that transforms the digital sound data to a continuous analog electrical signal that drives the loudspeaker 38. Furthermore, it is possible to capture still images and video via a camera 40 that is managed by an imaging module 42. Again, the camera 40 is referred to generally, and is not intended to be limited to conventional photo sensors. Other types of sensors such as LIDAR, radar, thermal, and so on may also be integrated.

Due to its inherent mobility, users can access information and interact with the mobile computing device 14 practically anywhere. Additional context in this regard is discernible from inputs pertaining to location, movement, and physical and geographical orientation, which further enhance the user experience. Accordingly, the mobile computing device includes a location module 44, which may be a Global Positioning System (GPS) receiver that is connected to a separate antenna 46 and generates coordinates data of the current location as extrapolated from signals received from the network of GPS satellites. Motions imparted upon the mobile computing device 14, as well as the physical and geographical orientation of the same, may be captured as data with a motion subsystem 48, in particular, with an accelerometer 50, a gyroscope 52, and/or a compass/magnetometer 54, respectively. Although in some embodiments the accelerometer 50, the gyroscope 52, and the compass 54 directly communicate with the central processor 20, more recent variations of the mobile computing device 14 utilize the motion subsystem 48 that is embodied as a separate co-processor to which the acceleration and orientation processing is offloaded for greater efficiency and reduced electrical power consumption. One exemplary embodiment of the mobile computing device 14 is the Apple iPhone with the M7 motion co-processor.

The components of the motion subsystem 48, including the accelerometer 50, the gyroscope 52, and the magnetometer 54, while shown as integrated into the mobile computing device 14, may be incorporated into a separate, external device. This external device may be wearable by the user and communicatively linked to the mobile computing device 14 over the aforementioned data link modalities. The same physical interactions contemplated with the mobile computing device 14 to invoke various functions as discussed in further detail below may be possible with such external wearable device.

There are other sensors 56 that can be utilized in the mobile computing device 14 for different purposes. For example, one of the other sensors 56 may be a proximity sensor to detect the presence or absence of the user to invoke certain functions, while another may be a light sensor that adjusts the brightness of the display 12 according to ambient light conditions. Those having ordinary skill in the art will recognize that other sensors 56 beyond those considered herein are also possible.

The foregoing input and output modalities of the mobile computing device 14 are utilized to navigate and otherwise interact with the augmented reality environment 10. Returning to the exemplary screen shown in FIG. 1, there may be images 58 or portions of images of a physical space 60, along with rendering parameters therefor that are captured in real-time by the onboard camera 40. The video feed from the camera 40 may be reproduced directly within the augmented reality environment 10 in accordance with known techniques. The images 58 may also be rendered from a video stream originating from a different camera other than the one onboard the mobile computing device 14. Such video stream may be passed to the mobile computing device 14 in real-time or near real-time (accounting for delays in transmission from the camera to a central server, then to the mobile computing device 14). Additionally, pre-recorded footage captured at a different time using a different video source may also be presented within the augmented reality environment 10.

In addition to the images from the physical space 60, the augmented reality environment 10 may include overlays 62 that are generated therein from data associated with a specific position within the environment. For example, street marker identified by reference number 62 may be particularly associated with that location along the street, and presented above the representation of the street shown within the augmented reality environment 10. A variety of input modalities may be used to navigate the augmented reality environment 10, one such system being disclosed in U.S. Pat. No. 9,983,687 and entitled “Gesture-Controlled Augmented Reality Experience Using a Mobile Communications Device,” the entire disclosure of which is hereby incorporated by reference.

Additionally rendered within the augmented reality environment 10 may be one or more objects 64 that are indicators for information that is associated with a particular position in the physical space 60 and its corresponding simulated space. In an exemplary map/navigation application that presents information on points of interest in the vicinity of an augmented reality viewpoint location/origin 66, these objects 64 may include the name of an establishment, a descriptive image associated with the establishment, and to the extent any reviews/ratings are available, then an aggregate rating value. The user may tap on the object 64 to see an expanded view of information relating to the establishment in a separate interface/window or the like.

It is also possible to adapt the various features of the present disclosure to augmented reality environments in which video footage (pre-recorded or live) can be viewed from the perspective of a camera at a location that is selected through the augmented reality interface. Such features are disclosed in further detail in co-owned U.S. Pat. No. 9,794,495 entitled “Multiple Streaming Camera Navigation Interface System,” the entirety of the disclosure of which is also incorporated by reference.

In accordance with the present disclosure, it has been recognized that such objects 64 and the overlays 62 may be difficult to view when numerous ones are being displayed within the augmented reality environment 10. Thus, the aggregating of the objects 64 using an underlying map grid system arranged by distance increments is contemplated. With the longitude and latitude origins of the objects 64, the distances from the augmented reality viewpoint location/origin 66 may be computed. Furthermore, the aggregation of the objects 64 may be based on relevancy such as the latest available video stream and/or image captured, or the most viewed cluster of objects 64.

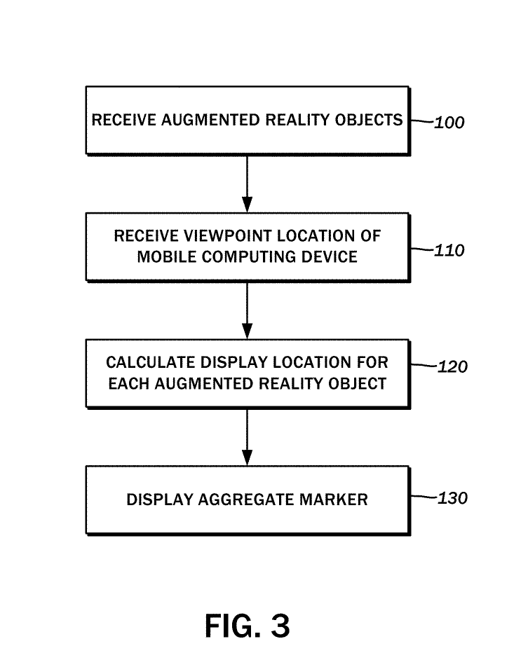

The present disclosure contemplates a method for selectively aggregating augmented reality objects in a live camera view, and this method is illustrated in the flowchart of FIG. 3. The method begins with a step 100 of receiving augmented reality objects in response to a query. As discussed above, the augmented reality environment 10 may begin with a view as shown in FIG. 1 and populated with the objects 64 that correspond to business or the like in the vicinity of the physical space 60. The relevant objects 64 may be retrieved based upon a query to a database that stores the objects 64, and only those that match the query parameters may be presented. Such query parameters may be, for example, restaurants, restaurants within a certain price point, restaurants with at least a threshold rating level, and so forth. Alternatively, the query may be for video streams taken from specific perspectives/locations within view of the augmented reality environment 10.

In either case, a database on which the objects 64 and the underlying information corresponding thereto is stored is queried as an initial precursor step to retrieve the pertinent objects 64 to the be presented within the augmented reality environment 10. Because the objects 64 are placed within the augmented reality environment 10 based upon real-world locations, each have an associated object location value. A variety of modalities for specifying the object location value are possible, including longitude/latitude coordinates as would be specified in a GPS-based mapping system, as well as street addresses.

Next, in accordance with a step 110, an augmented reality viewpoint location/origin 66 of the mobile computing device 14 is received. This location is associated with the current live camera view being presented in the augmented reality environment 10, and defines the particular positioning of the objects 64 that were returned in the query.

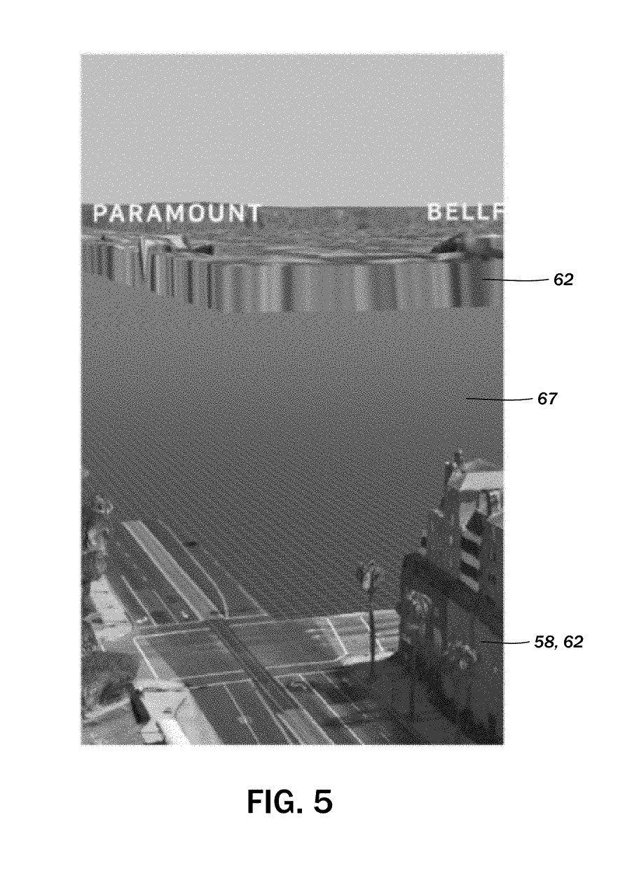

The method continues with a step 120 of calculating a display location within the camera view. A grid 67 that is a simplified representation of the aforementioned map is shown in FIG. 3, which is defined in terms of longitude coordinates 68 and latitude coordinates 70, shows a first cluster 72a of objects 64, a second cluster 72b, and a third cluster 72c across the grid 67. The grid 67, in turn, corresponds to the area presented within the augmented reality environment 10. As indicated above, a perspective/three-dimensional view is shown, and so the augmented reality environment 10 may be generally described as a series of gradually increasing distance intervals as shown in an scale 71 that may be defined relative to the number of meters away from the augmented reality viewpoint location/origin 66. The display location is calculated from the aforementioned object location and the augmented reality viewpoint location/origin 66. A fusion of the map grid system combined with the augmented reality environment 10 is illustrated in an example screen capture of FIG. 5. As shown, a perspective view of a particular physical location is shown, with the underlying grid 67 being visible. A given object is positioned/evaluated in accordance with this grid 67, and displayed or aggregated with others nearby.

The method concludes with a step 130 of displaying an aggregate marker 74 within the live camera view/augmented reality environment 10. The aggregate marker 74 is generated to the extent the display locations of two or more of the objects 64 differ by less than a prescribed threshold. This is understood to aggregate clusters of the objects 64, such as the aforementioned first cluster 72a, the second cluster 72b, and the third cluster 72c. These, in turn, correspond to a first aggregate marker 74a, a second aggregate marker 74b, and a third aggregate marker 74c, respectively. The threshold for determining what objects 64 are to be grouped into a cluster 72 may be based on one or more of several parameters such as the shape of the object 64, the size of the object 64, and dimensions of the object 64.

The aggregation and presentation of the aggregate markers 74 can be based on relevancy data that is also associated with the objects 64. For example, in the context of the augmented reality environment 10 being used for accessing different other live camera views, the latest video and/or image taken may be highlighted. In this regard, the aggregation and presentation is understood to be based on the time stamp associated with the objects 64. Alternatively, the relevancy data may be derived from user interaction data such as the number of views of the video stream and so forth. Along these lines, alternative aggregations may be derived based on location and user mood/activity status derived from social media postings. The aggregate marker 74 that is ultimately shown in the augmented reality environment 10 may be that which corresponds to the object 64 having the greatest relevancy value from among the objects 64 that are being aggregated.

Any given aggregate marker 74 may be visually embellished relative to the other aggregate markers 74 within the augmented reality environment 10 like the third aggregate marker 74c to the extent any one has a higher degree of relevance. These embellishments include highlights in different colors, larger sizes, and so forth. Heat maps and other like graphical summarization techniques may be used to represent the clusters 72 as well. These graphical embellishments may be numbered for better understanding and readability.

Haptic interactions (tapping, zooming, etc.) with the aggregate marker 74 may be operative to generate a secondary interface allowing the user to “dive deeper” into certain clusters 72 for additional information. Such a secondary interface may be a simple “in-feed” type layout, or the augmented reality environment 10, including the various images 58 and the overlays 62 therein, may be zoomed in for a deeper view. The clustering/aggregation step may then be performed again in the revised view of the augmented reality environment 10, utilizing the aforementioned arrangement/positioning process.

It is expressly contemplated that the augmented reality environment 10 is continuously updated with the most recent images 58 from the camera (whether onboard or remote), and updates the position of the presented objects and aggregate markers 74 based on location readings for the augmented reality viewpoint location/origin 66. The augmented reality environment 10 may adjust the view according to attitude (viewing angle) changes and other motions imparted to the mobile computing device 14 and tracked with the onboard sensors 56. A more accurate presentation of the aggregate markers 74 and the objects 64 may be possible with the use of depth sensor measurements that are combined with the live camera view. Thus, there is contemplated to be a fusion of map application data with live-stream camera views and its location, along with other sensor features of the mobile computing device 14.

The present disclosure thus envisions substantial interactivity enhancements in livestreaming social media augmented reality environments. Furthermore, consumer-friendly and useful visualizations of augmented reality data are possible. The particulars shown herein are by way of example and for purposes of illustrative discussion of the embodiments of the present disclosure only and are presented in the cause of providing what is believed to be the most useful and readily understood description of the principles and conceptual aspects. In this regard, no attempt is made to show details of the present invention with more particularity than is necessary, the description taken with the drawings making apparent to those skilled in the art how the several forms of the present invention may be embodied in practice.

What is claimed is:

1. A method for selectively aggregating augmented reality objects in a live camera view, the method comprising:
receiving a plurality of augmented reality objects in response to a query, each of the augmented reality objects being associated with an object location on a map;
receiving a viewpoint location of a mobile computing device displaying a live camera view;
for each of the augmented reality objects, calculating a display location within the live camera view, the display location being calculated from the object location of the augmented reality object and the viewpoint location; and
displaying an aggregate marker within the live camera view in response to the display locations of two or more of the augmented reality objects differing by less than a threshold.

2. The method of claim 1, further comprising determining the aggregate marker based on a relevance value of each of the two or more augmented reality objects.

3. The method of claim 2, wherein the relevance value of each of the two or more augmented reality objects is derived from a time stamp of the augmented reality object.

4. The method of claim 2, wherein the relevance value of each of the two or more augmented reality objects is derived from user interaction data of the augmented reality object.

5. The method of claim 2, wherein the aggregate marker comprises the augmented reality object having the greatest relevance value from among the two or more augmented reality objects.

6. The method of claim 1, wherein the map is a two-dimensional grid and the object location of each of the augmented reality objects comprises a location on the two-dimensional grid.

7. The method of claim 6, wherein the object location of each of the augmented reality objects comprises a longitude value and a latitude value.

8. The method of claim 1, wherein the map is a three-dimensional grid and the object location of each of the augmented reality objects comprises a location within the three-dimensional grid.

9. The method of claim 8, wherein the object location of each of the augmented reality objects comprises a longitude value and a latitude value.

10. The method of claim 1, wherein the viewpoint location comprises a longitude value and a latitude value.

11. The method of claim 1, wherein said calculating the display location for each of the augmented reality objects includes calculating a distance between the object location of the augmented reality object and the viewpoint location.

12. The method of claim 1, wherein the display location for each of the augmented reality objects is further calculated from an attitude of the mobile computing device.

13. The method of claim 1, wherein the display location for each of the augmented reality objects is further calculated from a depth sensor measurement associated with the live camera view.

14. The method of claim 1, wherein the display location for each of the augmented reality objects is further calculated from a motion tracking measurement associated with the live camera view.

15. The method of claim 1, further comprising calculating the threshold from display data associated with the two or more augmented reality objects.

16. The method of claim 15, wherein the display data associated with each of the two or more augmented reality objects includes one or more parameters selected from the group consisting of a shape of the augmented reality object, a size of the augmented reality object, and a dimension of the augmented reality object.

17. The method of claim 1, wherein the aggregate marker comprises one of the two or more augmented reality objects.

18. The method of claim 1, further comprising connecting the mobile computing device to an augmented reality stream including the plurality of augmented reality objects in response to a user selection.

19. A non-transitory program storage medium on which are stored instructions executable by a processor or programmable circuit to perform operations for selectively aggregating augmented reality objects in a live camera view, the operations comprising:
receiving a plurality of augmented reality objects in response to a query, each of the augmented reality objects being associated with an object location on a map;
receiving a viewpoint location of a mobile computing device displaying a live camera view;
for each of the augmented reality objects, calculating a display location within the live camera view, the display location being calculated from the object location of the augmented reality object and the viewpoint location; and
displaying an aggregate marker within the live camera view in response to the display locations of two or more of the augmented reality objects differing by less than a threshold.

20. A system for selectively aggregating augmented reality objects in a live camera view, the system comprising:
a mobile computing device operable to display a live camera view; and
one or more servers that receive a plurality of augmented reality objects in response to a query, each of the augmented reality objects associated with an object location on a map, receive a viewpoint location of the mobile computing device, and, for each of the augmented reality objects, calculate a display location within the live camera view, the display location calculated from the object location of the augmented reality object and the viewpoint location;
wherein the mobile computing device displays an aggregate marker within the live camera view in response to the display locations of two or more of the augmented reality objects differing by less than a threshold.
